(19) United States
(12) Patent Application Publication
(10) Pub. No.: US 2024/0046113 A1
(43) Pub. Date: Feb. 8, 2024

(54) DATA STORAGE METHOD, DATA ACQUISITION METHOD, DATA ACQUISITION APPARATUS FOR A WEIGHT MATRIX, AND DEVICE

(71) Applicant: LYNXI TECHNOLOGIES CO., LTD., Beijing (CN)

(72) Inventors: Zhenzhi WU, Beijing (CN); Minghe YANG, Beijing (CN); Yaolong ZHU, Beijing (CN)

(21) Appl. No.: 18/266,658

(22) PCT Filed: May 26, 2022
(86) PCT No.: PCT/CN2022/095238

§ 371 Date: Jun. 12, 2023

(30) Foreign Application Priority Data
May 27, 2021 (CN) 202110585727.0
May 27, 2021 (CN) 202110585872.9

(51) Int. Cl. G06N 3/10

(52) U.S. Cl. CPC G06N 3/10

(57) ABSTRACT

The present disclosure relates to a data storage method, a data acquisition method, and a data acquisition apparatus for a weight matrix, and a device. The data storage method includes: generating a coding array and a special value table according to the weight matrix; and storing the coding array and the special value table. The coding array and the special value table occupy a storage space smaller than the weight matrix.

### CROSS-REFERENCE TO RELATED APPLICATIONS

The present application is a National Phase Application filed under 35 U.S.C. 371 as a national stage of PCT/CN2022/095238, filed on May 26, 2022, an application claiming priority from Chinese Patent Application 202110585872.9, filed on May 27, 2021 in the Chinese Intellectual Property Office, and Chinese Patent Application No. 202110585727.0, filed on May 27, 2021 in the Chinese Intellectual Property Office, contents of which are hereby incorporated herein by reference in their entirety.

### TECHNICAL FIELD

Embodiments of the present disclosure relates to the technical field of artificial intelligence, and particularly relates to a data storage method, a data acquisition method, and a data acquisition apparatus for a weight matrix, an electronic device, and a computer-readable storage medium.

### BACKGROUND

The brain inspired computing technology has been widely applied to the fields of intelligence science, cognitive science, information processing, artificial intelligence and the like, and can be used for recognition and processing of texts, images, audios and videos and the like.

A human brain includes a great number of neurons (e.g., about 1000 billion), while a brain inspired chip (neuromorphic chip) simulates operation of the human brain by providing a large number of electronically simulated neurons. Operation of the neurons involves a plurality of “weights (e.g., connection weights)”, which may exist in a form of “weight matrix”, where each element of the weight matrix is a weight value (e.g., a connection weight value).

### SUMMARY

Embodiments of the present disclosure provide a data storage method, a data acquisition method, and a data acquisition apparatus for a weight matrix, an electronic device, and a computer-readable storage medium, which can effectively reduce the storage space occupied by the weight matrix.

In a first aspect, an embodiment of the present disclosure provides a data storage method for a weight matrix, including: generating a coding array and a special value table according to the weight matrix; and storing the coding array and the special value table, wherein the coding array and the special value table occupy a storage space smaller than the weight matrix, and the special value table includes all special weight values in the weight matrix which are sequentially arranged.

In some embodiments, the coding array includes a connection matrix and a data type table, wherein the connection matrix has a same structure as the weight matrix, and elements of the connection matrix are connection types of weight values of corresponding elements in the weight matrix, at least some of the connection types have a data volume smaller than the corresponding weight values, and the connection types are classified into valid connection and invalid connection, the data type table includes data types which are sequentially arranged and correspond to weight values in the connection type of valid connection in the weight matrix, at least some of the data types have a data volume smaller than the corresponding weight values, and the data types include a special value type and a plurality of first preset value types, each first preset value type corresponds to a first preset weight value, which is a preset weight value in the connection type of valid connection, the special value type corresponds to the special weight values, and other weight values in the connection type of valid connection, except the first preset weight value, belong to the special weight values.

In some embodiments, the coding array includes a type matrix, and wherein the type matrix has a same structure as the weight matrix, and elements of the type matrix are types of weight values of corresponding elements in the weight matrix, at least some of the types have a data volume smaller than the corresponding weight values, the types include a special value type and a plurality of second preset value types, each second preset value type corresponds to a second preset weight value, the special value type corresponds to the special weight values, and other weight values, except the second preset weight value, belong to the special weight values.

In a second aspect, an embodiment of the present disclosure provides a data storage method for a weight matrix, including: generating a connection matrix, a data type table and a special value table according to the weight matrix; and storing the connection matrix, the data type table and the special value table, wherein the connection matrix has a same structure as the weight matrix, each element of the connection matrix is a connection type of a weight value of a corresponding element in the weight matrix, one connection type has a data volume smaller than one weight value, and the connection types are classified into valid connection and invalid connection; the data type table includes data types which are sequentially arranged and correspond to weight values in the connection type of valid connection in the weight matrix, one data type has a data volume smaller than one weight value, the data types include a special value type and a plurality of preset value types, each preset value type corresponds to a preset weight value in the connection type of valid connection, the special value type corresponds to special weight values, and other weight values in the connection type of valid connection, except the preset weight value, are the special weight values; and the special value table includes all the special weight values in the weight matrix which are sequentially arranged.

In a third aspect, an embodiment of the present disclosure provides a data storage method for a weight matrix, including: generating a type matrix and a special value table according to the weight matrix; and storing the type matrix and the special value table; wherein the type matrix has a same structure as the weight matrix, each element of the type matrix is a type corresponding to a weight value of a corresponding element in the weight matrix, one type has a data volume smaller than one weight value, the types include a special value type and a plurality of preset value types, each preset value type corresponds to one preset weight value, the special value type corresponds to special weight values, and other weight values, except the preset weight value, are the special weight values; and the special value table includes all the special weight values in the weight matrix which are sequentially arranged.

In a fourth aspect, an embodiment of the present disclosure provides a data acquisition method for a weight matrix, including: determining, according to a prestored coding array and a prestored special value table, a weight value of a corresponding element in the weight matrix; and acquiring the determined weight value, wherein the coding array and the special value table occupy a storage space smaller than the weight matrix, and the special value table includes all special weight values in the weight matrix which are sequentially arranged.

In some embodiments, the coding array includes a connection matrix and a data type table, wherein the connection matrix has a same structure as the weight matrix, and elements of the connection matrix are connection types of weight values of corresponding elements in the weight matrix, at least some of the connection types have a data volume smaller than the corresponding weight values, and the connection types are classified into valid connection and invalid connection, the data type table includes data types which are sequentially arranged and correspond to weight values in the connection type of valid connection in the weight matrix, at least some of the data types have a data volume smaller than the corresponding weight values, and the data types include a special value type and a plurality of first preset value types, each first preset value type corresponds to a first preset weight value, which is a preset weight value in the connection type of valid connection, the special value type corresponds to the special weight values, and other weight values in the connection type of valid connection, except the first preset weight value, belong to the special weight values.

In some embodiments, the coding array includes a type matrix, and wherein the type matrix has a same structure as the weight matrix, and elements of the type matrix are types of weight values of corresponding elements in the weight matrix, at least some of the types have a data volume smaller than the corresponding weight values, the types include a special value type and a plurality of second preset value types, each second preset value type corresponds to a second preset weight value, the special value type corresponds to the special weight values, and other weight values, except the second preset weight value, belong to the special weight values.

In a fifth aspect, an embodiment of the present disclosure provides a data acquisition method for a weight matrix, including: determining, according to prestored connection matrix, data type table and special value table, a weight value of a corresponding element in the weight matrix, wherein the connection matrix has a same structure as the weight matrix, each element of the connection matrix is a connection type of a weight value of a corresponding element in the weight matrix, one connection type has a data volume smaller than one weight value, and the connection types are classified into valid connection and invalid connection; the data type table includes data types which are sequentially arranged and correspond to weight values in the connection type of valid connection in the weight matrix, one data type has a data volume smaller than one weight value, the data types include a special value type and a plurality of preset value types, each preset value type corresponds to a preset weight value in the connection type of valid connection, the special value type corresponds to special weight values, and other weight values in the connection type of valid connection, except the preset weight value, are the special weight values; and the special value table includes all the special weight values in the weight matrix which are sequentially arranged.

In a sixth aspect, an embodiment of the present disclosure provides a data acquisition method for a weight matrix, including: determining, according to types of elements of a prestored type matrix, a prestored special value table and preset weight values, a weight value of a corresponding element in the weight matrix, wherein the type matrix has a same structure as the weight matrix, each element of the type matrix is a type corresponding to a weight value of a corresponding element in the weight matrix, one type has a data volume smaller than one weight value, the types include a special value type and a plurality of preset value types, each preset value type corresponds to one preset weight value, the special value type corresponds to special weight values, and other weight values, except the preset weight value, are the special weight values; and the special value table includes all the special weight values in the weight matrix which are sequentially arranged.

In a seventh aspect, an embodiment of the present disclosure provides a data acquisition apparatus for a weight matrix, including: a processing unit and at least one acquisition unit, wherein the processing unit is configured to determine, according to a prestored coding array and a prestored special value table, a weight value of a corresponding element in the weight matrix, and the acquisition unit is configured to acquire the determined weight value, wherein the coding array and the special value table occupy a storage space smaller than the weight matrix, and the special value table includes all special weight values in the weight matrix which are sequentially arranged.

In some embodiments, the coding array includes a connection matrix and a data type table, and the processing unit includes: an address generator, a special value memory, an invalid value memory, and a first preset value memory, wherein the connection matrix has a same structure as the weight matrix, and elements of the connection matrix are connection types of weight values of corresponding elements in the weight matrix, at least some of the connection types have a data volume smaller than the corresponding weight values, and the connection types are classified into valid connection and invalid connection; the data type table includes data types which are sequentially arranged and correspond to weight values in the connection type of valid connection in the weight matrix, at least some of the data types have a data volume smaller than the corresponding weight values, and the data types include a special value type and a plurality of first preset value types, each first preset value type corresponds to a first preset weight value, which is a preset weight value in the connection type of valid connection, the special value type corresponds to the special weight values, and other weight values in the connection type of valid connection, except the first preset weight value, belong to the special weight values; the address generator is configured to sequentially generate addresses of elements in the connection matrix, and input the addresses to a connection matrix memory of a corresponding acquisition unit; the first preset value memory is configured to store the first preset weight value, and synchronously input the first preset weight value to a second gate of the acquisition unit; the invalid value memory is configured to store an invalid weight value and input the invalid weight value to a first gate of the acquisition unit; the special value memory is configured to store the special value table, input a current special weight value in the special value table to the second gate, and update, upon receiving an updating signal, the current special weight value to a next special weight value in the special value table; and the acquisition unit includes: the connection matrix memory configured to store the connection matrix and input, according to the received addresses, connection types of corresponding elements in the connection matrix to the first gate and a data type memory; the data type memory configured to input, upon receiving a valid connection, a corresponding data type of the data type table prestored in the data type memory to the second gate and a special value determiner; the special value determiner configured to output an updating signal to the special value memory upon receiving a data type being a special value type; the second gate configured to select one of the received current special weight value or the first preset weight value to output according to the received data type; and the first gate configured to select one of the received invalid weight value or an output of the second gate to output according to the received connection type.

In some embodiments, the coding array includes a type matrix, and the processing unit includes: an address generator, a special value memory, and a second preset value memory, wherein the type matrix has a same structure as the weight matrix, and elements of the type matrix are types of weight values of corresponding elements in the weight matrix, at least some of the types have a data volume smaller than the corresponding weight values, the types include a special value type and a plurality of second preset value types, each second preset value type corresponds to a second preset weight value, the special value type corresponds to the special weight values, and other weight values, except the second preset weight value, belong to the special weight values; the address generator is configured to sequentially generate addresses of elements in the type matrix, and input the addresses to a type matrix memory of a corresponding acquisition unit; the second preset value memory is configured to store the second preset weight value, and synchronously input the second preset weight value to a third gate of the acquisition unit; the special value memory is configured to store the special value table, input a current special weight value in the special value table to the third gate, and update, upon receiving an updating signal, the current special weight value to a next special weight value in the special value table; and the acquisition unit includes: the type matrix memory configured to store the type matrix, and input, according to the received addresses, types of corresponding elements in the type matrix to the third gate and a special value determiner; the special value determiner configured to output an updating signal to the special value memory upon receiving a type being a special value type; and the third gate configured to select one of the received current special weight value or the second preset weight value to output according to the received type.

In an eighth aspect, an embodiment of the present disclosure provides a data acquisition apparatus for a weight matrix, including an address generator, a special value memory, an invalid value memory, a preset value memory, and at least one acquisition unit, wherein the address generator is configured to sequentially generate addresses of elements in a connection matrix, and input the addresses to a connection matrix memory of a corresponding acquisition unit; the preset value memory is configured to store all preset weight values, and synchronously input the preset weight values to second gates of all acquisition units; the invalid value memory is configured to store an invalid weight value, and input the invalid weight value to first gates of all the acquisition units; the special value memory is configured to store a special value table, input a current special weight value in the special value table to the second gates, and update, upon receiving an updating signal, the current special weight value to a next special weight value in the special value table; and each acquisition unit includes: the connection matrix memory configured to store the connection matrix, and input, according to the received addresses, connection types of corresponding elements in the prestored connection matrix to the first gate and a data type memory; the data type memory configured to input, upon receiving a valid connection, a corresponding data type of the data type table prestored in the data type memory to the second gate and a special value determiner; the special value determiner configured to output an updating signal to the special value memory upon receiving a data type being a special value type; the second gate configured to select one of the received current special weight value or the preset weight values to output according to the received data type; and the first gate configured to select one of the received invalid weight value or an output of the second gate to output according to the received connection type, wherein the connection matrix has a same structure as the weight matrix, and each element of the connection matrix is a connection type of a weight value of a corresponding element in the weight matrix; one connection type has a data volume smaller than one weight value, and the connection types are classified into valid connection and invalid connection; the data type table includes data types which are sequentially arranged and correspond to weight values in the connection type of valid connection in the weight matrix; one data type has a data volume smaller than one weight value, the data types include a special value type and a plurality of preset value types, each preset value type corresponds to a preset weight value in the connection type of valid connection, the special value type corresponds to special weight values, and other weight values in the connection type of valid connection, except the preset weight value, are the special weight values; and the special value table includes all the special weight values in the weight matrix which are sequentially arranged.

In a ninth aspect, an embodiment of the present disclosure provides a data acquisition apparatus for a weight matrix, including an address generator, a special value memory, a preset value memory, and at least one acquisition unit, wherein the address generator is configured to sequentially generate addresses of elements in a type matrix, and input the addresses to a type matrix memory of a corresponding acquisition unit; the preset value memory is configured to store all preset weight values, and synchronously input the preset weight values to gates of all acquisition units; the special value memory is configured to store a special value table, input a current special weight value in the special value table to the gates, and update, upon receiving an updating signal, the current special weight value to a next special weight value in the special value table; and each acquisition unit includes: the type matrix memory configured to store the type matrix, and input, according to the received addresses, types of corresponding elements in the type matrix to the gate and a special value determiner; the special value determiner configured to output an updating signal to the special value memory upon receiving a type being a special value type; and the gate configured to select one of the received current special weight value or the preset weight values to output according to the received type, wherein the type matrix has a same structure as the weight matrix, each element of the type matrix is a type corresponding to a weight value of a corresponding element in the weight matrix, and one type has a data volume smaller than one weight value; the types include a special value type and a plurality of preset value types; each preset value type corresponds to one preset weight value, the special value type corresponds to special weight values, and other weight values, except the preset weight value, are the special weight values; and the special value table includes all the special weight values in the weight matrix which are sequentially arranged.

In a tenth aspect, an embodiment of the present disclosure provides an electronic device, including a memory, a processor, and a computer program stored in the memory and executable on the processor, wherein the processor, when executing the computer program, implements the data storage method for a weight matrix or the data acquisition method for a weight matrix according to any embodiment of the present disclosure.

In an eleventh aspect, an embodiment of the present disclosure provides a computer-readable storage medium storing a computer program thereon which, when executed by a processor, causes the data storage method for a weight matrix or the data acquisition method for a weight matrix according to any embodiment of the present disclosure to be implemented.

It will be appreciated that the foregoing general description and the following detailed description are merely exemplary and explanatory, and are not intended to limit the present disclosure. Further features and aspects of the present disclosure will become apparent from the following detailed description of exemplary embodiments with reference to the attached drawings.

### BRIEF DESCRIPTION OF DRAWINGS

FIG. 1 is a flowchart of a data storage method for a weight matrix according to the present disclosure;

FIG. 2 is a flowchart of a data storage method for a weight matrix according to the present disclosure;

FIG. 3 is a diagram illustrating a correspondence relationship between a weight matrix and a connection matrix according to the present disclosure;

FIG. 4 is a flowchart of a data storage method for a weight matrix according to the present disclosure;

FIG. 5 is a flowchart of a data storage method for a weight matrix according to the present disclosure;

FIG. 6 is a diagram illustrating a correspondence relationship between a weight matrix and a type matrix according to the present disclosure;

FIG. 7 is a flowchart of a data storage method for a weight matrix according to the present disclosure;

FIG. 8 is a flowchart of a data acquisition method for a weight matrix according to the present disclosure;

FIG. 9 is a flowchart of a data acquisition method for a weight matrix according to the present disclosure;

FIG. 10 is a flowchart of a data acquisition method for a weight matrix according to the present disclosure;

FIG. 11 is a flowchart of a data acquisition method for a weight matrix according to the present disclosure;

FIG. 12 is a block diagram of a data acquisition apparatus for a weight matrix according to the present disclosure;

FIG. 13 is another block diagram of a data acquisition apparatus for a weight matrix according to the present disclosure;

FIG. 14 is a flowchart of a data acquisition method for a weight matrix according to the present disclosure;

FIG. 15 is another flowchart of a data acquisition method for a weight matrix according to the present disclosure;

FIG. 16 is another flowchart of a data acquisition method for a weight matrix according to the present disclosure;

FIG. 17 is a block diagram of a data acquisition apparatus for a weight matrix according to the present disclosure;

FIG. 18 is another block diagram of a data acquisition apparatus for a weight matrix according to the present disclosure;

FIG. 19 is a block diagram of a data acquisition apparatus for a weight matrix according to the present disclosure; and

FIG. 20 is a block diagram of an electronic device provided in the present disclosure.

### DETAIL DESCRIPTION OF EMBODIMENTS

The present disclosure will now be further described in detail below in conjunction with the drawings and exemplary embodiments. It will be appreciated that the embodiments described herein are used merely for the purpose of explaining the present disclosure instead of limiting the present disclosure. It should be further noted that, for the convenience of description, merely some of the structures associated with the present disclosure, not all the structures, are shown in the drawings.

In a first aspect, an embodiment of the present disclosure provides a data storage method for a weight matrix, which is configured to store data (information) of the weight matrix for use in a subsequent brain inspired computing process.

The weight matrix is configured to store weights (such as weights of neurons) used in brain inspired computing. The weight matrix may be in a two or higher dimensional form, and each element in the weight matrix is a weight value.

All weight values in the weight matrix have a same precision, such as int8, fp16, or other forms.

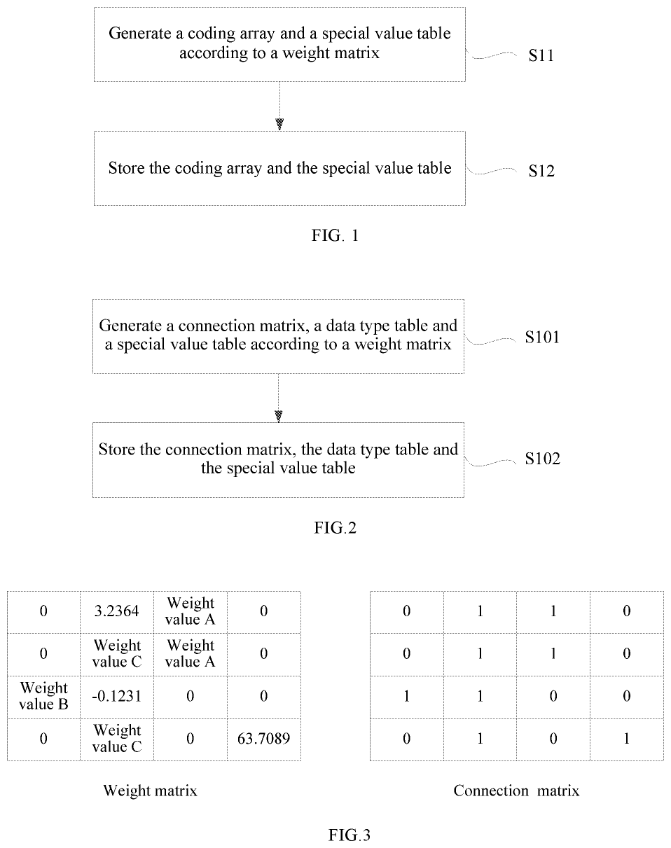

FIG. 1 is a flowchart of a data storage method for a weight matrix according to an embodiment of the present disclosure. Referring to FIG. 1, the data storage method according to the present disclosure includes the following operations S11 to S12.

At operation S11, generating a coding array and a special value table according to the weight matrix.

At operation S12, storing the coding array and the special value table.

The coding array and the special value table occupy a storage space smaller than the weight matrix. The special value table includes all special weight values in the weight matrix which are sequentially arranged.

In some possible implementations, one or more coding arrays are provided, elements in the coding arrays are types of weight values of corresponding elements in the weight matrix, and at least some of the types have a data volume smaller than the corresponding weight values. The special value table includes a plurality of special weight values in the weight matrix which are sequentially arranged. The special weight values include weight values in the weight matrix except a preset weight value, and the preset weight value is a weight value preset in advance.

In a neural network, some neurons are in a dormant state, corresponding to an invalid connection, while other neurons are in a non-dormant state, which may be inhibitory or excitatory. When brain simulation and other operations are carried out, the weight values of the neurons can be represented through several limited values. In some possible implementations, considering a problem that a single weight value occupies a relatively large data volume and that a plurality of weight values have a same value, causing a large data volume of the weight matrix, the storage space occupied by the weight matrix can be reduced by encoding, and then storing, the weight values in the weight matrix. In some possible implementations, the coding array may include a connection matrix and a data type table.

The connection matrix has a same structure as the weight matrix, and elements of the connection matrix are connection types of weight values of corresponding elements in the weight matrix. At least some of the connection types have a data volume smaller than the corresponding weight values, and the connection types are classified into valid connection and invalid connection.

The data type table includes data types which are sequentially arranged and correspond to weight values in the connection type of valid connection in the weight matrix. At least some of the data types have a data volume smaller than the corresponding weight values, and the data types include a special value type and a plurality of first preset value types, each first preset value type corresponds to a first preset weight value, which is a preset weight value in the connection type of valid connection, the special value type corresponds to special weight values, and other weight values in the connection type of valid connection, except the first preset weight value, belong to the special weight values.

In other words, the weight matrix may be converted into a corresponding connection matrix, data type table and special value table according to the connection status and the data type of each weight value in the weight matrix. That is, the coding array include two types of codes, one is generated based on the connection status of the weight values, corresponding to the connection matrix, and the other is generated according to the data types of the weight values, corresponding to the data type table and the special value table. Accordingly, the connection matrix is used to represent whether each weight value in the weight matrix is in the connection type of valid connection (or invalid connection), the data type table corresponds to the data types of the weight values in the connection type of valid connection, and the special value table includes several special weight values. In a storage operation, the connection matrix, the data type table, and the special value table are directly stored.

In some possible implementations, the coding array may further include a type matrix. The type matrix has a same structure as the weight matrix, and elements of the type matrix are types of weight values of corresponding elements in the weight matrix, and at least some of the types have a data volume smaller than the corresponding weight values. The types include a special value type and a plurality of second preset value types. Each second preset value type corresponds to a second preset weight value, the special value type corresponds to special weight values, and other weight values, except the second preset weight value, belong to the special weight values.

In other words, the weight matrix may be converted into a corresponding type matrix and a special value table according to the types of the weight values in the weight matrix (including a valid connection/invalid connection type and a data type). That is, there is merely a single type of code in the coding array, which is determined and generated according to the valid connection/invalid connection type and the data type of the weight values. Accordingly, the type matrix can represent not only whether each weight value is in the connection type of valid connection/invalid connection, but also a data type of each weight values in the connection type of valid connection. In a storage operation, the type matrix and the special value table are directly stored.

It should be noted that the above merely describes an example of the coding array, and the coding array may also be arranged in other manners, which is not limited in the present disclosure.

In the present disclosure, for weight values that repeatedly appear in the weight matrix for multiple times, the weight values are represented and stored by codes of a smaller data volume by setting the coding array and the special value table, so that the occupation of storage space can be effectively reduced. Accordingly, in a case that the weight matrix is desired to be used, the weight matrix can be accurately restored according to the coding array, the special value table, and a prestored preset weight values.

The following describes a data storage method for a weight matrix according to embodiments of the present application in detail with reference to FIGS. 2 to 4.

FIG. 2 is a flowchart of a data storage method for a weight matrix according to the present disclosure. Referring to FIG. 2, the data storage method according to the present disclosure includes the following operations S101 to S102.

At operation S101, generating a connection matrix, a data type table and a special value table according to a weight matrix.

At operation S102, storing the connection matrix, the data type table and the special value table.

The connection matrix has a same structure as the weight matrix, and each element of the connection matrix is a connection type of a weight value of a corresponding element in the weight matrix. One connection type has a data volume smaller than one weight value, and the connection types are classified into valid connection and invalid connection.

The data type table includes data types which are sequentially arranged and correspond to weight values in the connection type of valid connection in the weight matrix. One data type has a data volume smaller than one weight value, the data types include a special value type and a plurality of preset value types, each preset value type corresponds to a preset weight value in the connection type of valid connection, the special value type corresponds to special weight values, and other weight values in the connection type of valid connection, except the preset weight value, are the special weight values.

The special value table includes all the special weight values in the weight matrix which are sequentially arranged.

In the present disclosure, according to the content (data) of the weight matrix to be stored, a corresponding connection matrix, data type table, and special value table are generated and stored, to reflect the information (data) of the weight matrix for use in a subsequent brain inspired computing process.

Referring to FIG. 3, the connection matrix has a same form and size as the weight matrix, so that each element in the connection matrix necessarily corresponds to an element at a same relative position in the weight matrix. Moreover, the value of each element in the connection matrix is a “connection type” to which the weight value of a corresponding element in the weight matrix belongs.

In the weight matrix, a part of the weight values is “useful” or “valid” in the subsequent brain inspired computing process, called “weighted” or “valid weight value”, and the connection type of these weight values is “valid connection”. Meanwhile, in the weight matrix, another part of the weight values is actually “useless” or “invalid” in the subsequent brain inspired computing process, called “unweighted” or “invalid weight value”, for example, having a weight value of 0, and the connection type of these weight values is “invalid connection”.

It can be seen that the weight values in the connection type of invalid connection actually correspond to 0 elements in the weight matrix, while the weight values in the connection type of valid connection actually correspond to non-0 elements in the weight matrix.

Since the weight values in the connection type of invalid connection do not play a practical role, there is no need to store “specific value” of these weight values, and instead, it is indicated in the connection matrix which elements in the weight matrix are 0 elements (weight values in the connection type of invalid connection) and which are non-0 elements (weight values in the connection type of valid connection).

For example, referring to FIG. 3, in the connection matrix, 1 represents valid connection (a non-0 element), 0 represents invalid connection (a 0 element).

Further, each weight value in the connection type of valid connection of the weight matrix has a certain “data type”. Exemplarily, many weight values in the connection type of valid connection in the weight matrix repeatedly appear for multiple times, such as some excitatory weight values, inhibitory weight values, null weight values, and the like, so that each weight value (a weight value in the connection type of valid connection) appearing for multiple times may be defined as a preset weight value belonging to a “preset value type”. In contrast, other weight values (weight values in the connection type of valid connection) in the weight matrix appearing fewer times are collectively defined as special weight values belonging to a “special value type”.

Therefore, the data types corresponding to the weight values in the connection type of valid connection in the weight matrix can be stored in a predetermined order (e.g., an order of arranging row by row) as a “data type table”. Thereby, the data type table actually includes a series of ordered data (data types), which can also be considered as a “one-dimensional matrix” or “sequence”.

For example, referring to FIG. 3 and tables 1 and 2 below, the preset weight values in the weight matrix may include a weight value A, a weight value B, and a weight value C, so that each data type in the data type table may have a data volume of 2 bits. For example, 01, and 00 are used to represent the three preset weight values (preset value types), i.e., the weight value A, the weight value B, and the weight value C, respectively, and 11 is used to represent a special weight value (special value type).

TABLE 1
Correspondence relationship between data types and weight values

| | 01 (preset value | 10 (preset value | 00 (preset value | 11 (special value |
|---|---|---|---|---|
| Data type | type) | type) | type) | type) |
| Weight value | Weight value A | Weight value B | Weight value C | Special weight |
| | | | | value |

TABLE 2
Data type table

| | | | | | | | | | |
|---|---|---|---|---|---|---|---|---|---|
| 11 | 01 | 00 | 01 | 10 | 11 | 00 | 11 | . . . | . . . |

All the special weight values of the weight matrix (i.e., all the weight values corresponding to the special value type in the data type table) may also be stored in sequence (in a same order as the data type table) as a special value table. Therefore, the special value table actually includes a series of ordered data (special weight values), which can also be considered as a “one-dimensional matrix” or “sequence”.

Referring to FIG. 3 and table 3 below, the special value table may be in the form of:

TABLE 3
Special value table

| | | | | | | | |
|---|---|---|---|---|---|---|---|
| 3.2364 | −0.1231 | 63.7089 | . . . | . . . | . . . | . . . | . . . |

Considering format requirements of the matrix, all elements in the table have a same data precision. Thus, for example, if each weight value has a data volume of 16 bits, a weight matrix containing N elements occupies a storage space of 16*N bits.

As discussed above, each element of the connection matrix may be either 1 or 0, and occupies a storage space of 1 bit, so a connection matrix corresponding to the above weight matrix occupies a storage space of N bits.

Assuming that 80% of the weights in the weight matrix are invalid weight values and merely 20% are valid weight values, then the data type table occupies a storage space of 20%*2*N bits, as described above.

Assuming that 5% of the weights in the weight matrix are special weight values, then the special value table occupies a storage space of 5%*16*N bits.

Therefore, the connection matrix, the data type table and the special value table together occupy a total storage space of N+20%*2*N+5%*16N=2.2N bits. Even if the storage space occupied by each preset weight value is added, merely 3*16=48 bits are added. When N takes a very large value, the storage space is much smaller than 16*N bits. Therefore, the method according to the present disclosure can greatly save the storage space.

Apparently, the larger the proportion of weight values in the connection type of invalid connection (invalid weight values) in the weight matrix is, and the larger the proportion of preset weight values in the weight values in the connection type of valid connection in the weight matrix is, the better the effect of saving the storage space can be obtained by the method according to the present disclosure. Therefore, the present disclosure is particularly suitable for a sparse matrix with a large proportion of invalid weight values.

For example, the present disclosure may be applied to a weight matrix in which weight values in the connection type of invalid connection (invalid weight values) occupy at least 40%, or at least 60%, or at least 80% (of the number of all weight values).

For another example, the present disclosure may be applied to a weight matrix in which preset weight values occupy at least 40%, or at least 60%, or at least 80% (of the number of weight values in the connection type of valid connection).

In the present disclosure, merely the connection matrix, the data type table, the special value table, and the preset weight values are actually stored. The connection matrix includes merely “connection types” of the weight values, the data type table includes merely “data types” of the weight values in the connection type of valid connection, and the data volume of each connection type or data type is obviously much smaller than the data volume of the weight value. Therefore, the connection matrix and the data type table occupy a storage space much smaller than the weight matrix; and since the special value table and the preset weight value cover merely a few weight values of the weight matrix, the two also occupy a very small storage space.

Therefore, in the present disclosure, all the actually stored data occupies a storage space much smaller than the weight matrix, but all information (data) of the weight matrix is actually included, thereby greatly saving the storage space.

In some embodiments, each connection type has a data volume of one bit.

As discussed above, since there are merely two connection types, each connection type has a data volume of one bit (1 bit), such as 1 or 0, as described above.

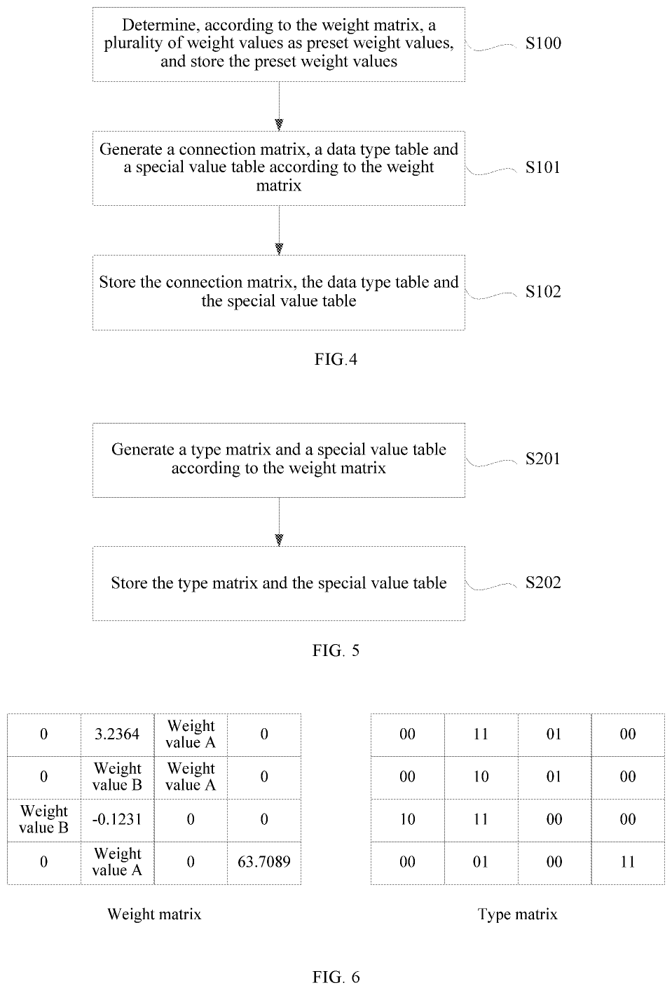

Referring to FIG. 4, in some embodiments, before generating the connection matrix, the data type table and the special value table according to the weight matrix (S101), the method further includes operation S100.

At operation S100, determining, according to the weight matrix, a plurality of weight values as preset weight values, and storing the preset weight values.

As discussed above, selection of the preset weight values has a notable influence on the effect of saving the storage space. If there are too few preset weight values, there will be too many special weight values, and the special value table will occupy a too large storage space; and if there are too many types of preset weight values, the data volume of each “data type” will become too large, and thereby, the data type table will occupy a too large storage space.

Therefore, according to the condition of a current weight matrix to be stored, some of the weight values, which appear for multiple times, may be selected as the preset weight values and stored, so that a better effect of saving the storage space can be achieved.

Apparently, instead of setting the preset weight values according to each weight matrix, common preset weight values may be preset and stored according to the overall situation of a large number of weight matrices. As described above, in some possible implementations, the coding array may further include a type matrix. The following describes a data storage method for a weight matrix according to embodiments of the present application in detail with reference to FIGS. 5 to 7. FIG. 5 is a flowchart of a data storage method for a weight matrix according to the present disclosure. Referring to FIG. 5, the data storage method according to the present disclosure includes the following operations S201 to S202.

At operation S201, generating a type matrix and a special value table according to the weight matrix.

At operation S202, storing the type matrix and the special value table.

The type matrix has a same structure as the weight matrix, each element of the type matrix is a type corresponding to a weight value of a corresponding element in the weight matrix, and one type has a data volume smaller than one weight value. The types include a special value type and a plurality of preset value types. Each preset value type corresponds to one preset weight value, the special value type corresponds to special weight values, and other weight values, except the preset weight value, are the special weight values. The special value table includes all the special weight values in the weight matrix which are sequentially arranged.

In the present disclosure, according to the content (data) of the weight matrix to be stored, the corresponding type matrix and special value table are generated and stored, to reflect the information (data) of the weight matrix for use in a subsequent brain inspired computing process.

Referring to FIG. 6, the type matrix has a same form and size as the weight matrix, so that each element in the type matrix necessarily corresponds to an element at a same relative position in the weight matrix. Moreover, the value of each element in the type matrix is a “type” to which the weight value of a corresponding element in the weight matrix belongs.

Apparently, in the weight matrix, many weight values repeatedly appear for multiple times, such as some excitatory weight values, inhibitory weight values, null weight values, and the like, so that each weight value appearing for multiple times may be defined as a preset weight value belonging to a “preset value type”. In contrast, other weight values in the weight matrix appearing fewer times are collectively defined as special weight values belonging to a “special value type”.

In the special value table, all the special weight values appearing in the weight matrix are stored in a predetermined order (e.g., an order of arranging row by row). Therefore, the special value table actually includes a series of ordered data (special weight values), which can also be considered as a “one-dimensional matrix” or “sequence”.

For example, referring to FIG. 6, the special value table may be in a form as shown by the special value table of table 3.

Further, considering format requirements of the matrix, all elements in the table have a same data precision. Thus, for example, if each weight value has a data volume of 16 bits, a weight matrix containing N elements occupies a storage space of 16*N bits.

As discussed above, generally, there are merely a few possible types of weight values, so each “type” has a data volume much smaller than a weight value. For example, referring to FIG. 6 and table 4 below, the preset weight values in the weight matrix may include a weight value A, a weight value B, and a null weight (represented by 0), so that each type in the type matrix may have a data volume of 2 bits. For example, 01, 10, and 00 are used to represent the three preset weight values, i.e., the weight value A, the weight value B, and the null weight, respectively, and 11 is used to represent a special weight value.

TABLE 4
Correspondence relationship table between types and weight values

| Type | 01 | 10 | 00 | 11 |
|---|---|---|---|---|
| Weight value | Weight value A | Weight value B | 0 | Special weight |
| | | | | value |

Therefore, the type matrix occupies a storage space of 2*N bits.

For example, when 80% of the elements in the weight matrix belong to the preset weight values, merely 20% of the elements are special weight values, and therefore, the special value table occupies a storage space of 20%*16*N bits.

Therefore, the data of the weight matrix (the type matrix and the special value table) stored in the above manner occupies a total storage space of 2*N+20%*16*N=5.2*N bits. Even if the storage space occupied by each preset weight value is added, merely 3*16=48 bits are added. When N takes a very large value, the storage space is much smaller than 16*N bits. Therefore, the method according to the embodiment of the present disclosure can greatly save the storage space.

Apparently, the larger the proportion (quantitative ratio) of preset weight values in the weight matrix is, the better the effect of saving the storage space can be obtained by the method according to the embodiment of the present disclosure. Therefore, the present disclosure is particularly suitable for a weight matrix with a large proportion of preset weight values, such as a sparse matrix with a large proportion of null weights (the null weight is a type of preset weight value).

For example, the embodiment of the present disclosure may be applied to a weight matrix in which preset weight values occupy at least 40%, or at least 60%, or at least 80% (of the number of all weight values).

In the present disclosure, merely the type matrix, the special value table, and the preset weight values are actually stored. The type matrix includes merely “types” of the weight values, where each type has a data volume much smaller than a weight value. Therefore, the type matrix occupies a storage space much smaller than the weight matrix. Further, since the special value table and the preset weight value cover merely a few weight values of the weight matrix, the two also occupy a very small storage space.

Therefore, in the present disclosure, all the actually stored data occupies a storage space much smaller than the weight matrix, but all information (data) of the weight matrix is actually included, thereby greatly saving the storage space.

In some embodiments, the preset weight values include: a null weight; and at least one preset, non-null weight value.

Many of the weight matrices are sparse matrices, where null weights take a large proportion (e.g., at least 40%, or at least 60%, or at least 80%), so the null weights can be taken as the preset weight values, while other non-null weight values are taken as weight values.

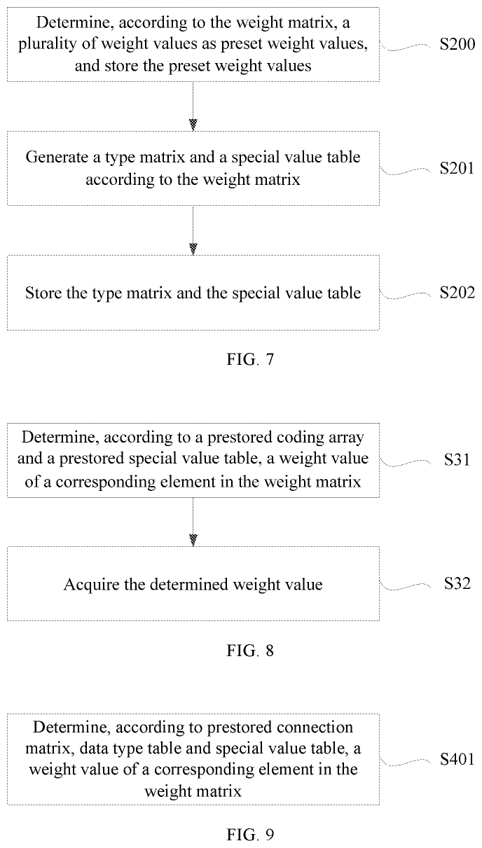

Referring to FIG. 7, in some embodiments, before generating the type matrix and the special value table according to the weight matrix (S201), the method further includes operation S200.

At operation S200, determining, according to the weight matrix, a plurality of weight values as preset weight values, and storing the preset weight values.

As discussed above, selection of the preset weight values has a notable influence on the effect of saving the storage space. If there are too few preset weight values, there will be too many special weight values, and the special value table will occupy a too large storage space; and if there are too many types of preset weight values, the data volume of each “type” will become too large, and thereby, the type matrix will occupy a too large storage space.

Therefore, according to the condition of a current weight matrix to be stored, some of the weight values, which appear for multiple times, may be selected as the preset weight values and stored, so that a better effect of saving the storage space can be achieved.

Apparently, instead of setting the preset weight values according to each weight matrix, common preset weight values may be preset and stored according to the overall situation of a large number of weight matrices.

In a second aspect, the present disclosure provides a data acquisition method for a weight matrix, which acquires desired weight values in the weight matrix from data of the weight matrix stored and obtained in the above methods, for use in a subsequent brain inspired computing process.

FIG. 8 is a flowchart of a data acquisition method for a weight matrix according to the present disclosure. Referring to FIG. 8, the data acquisition method according to the present disclosure includes the following operations S31 to S32.

At operation S31, determining, according to a prestored coding array and a prestored special value table, a weight value of a corresponding element in the weight matrix.

At operation S32, acquiring the determined weight value.

The coding array and the special value table occupy a storage space smaller than the weight matrix. The special value table includes all special weight values in the weight matrix which are sequentially arranged.

In some possible implementations, one or more coding arrays are provided, elements in the coding arrays are types of weight values of corresponding elements in the weight matrix, and at least some of the types have a data volume smaller than the corresponding weight values. The special value table includes a plurality of special weight values in the weight matrix which are sequentially arranged. The special weight values include weight values in the weight matrix except a preset weight value, and the preset weight value is a weight value preset in advance.

In some possible implementations, the coding array includes a connection matrix and a data type table.

Determining, according to the prestored coding array and the prestored special value table, the weight value of the corresponding element in the weight matrix includes: determining, according to a prestored connection matrix, data type table and special value table, the weight value of the corresponding element in the weight matrix.

The connection matrix has a same structure as the weight matrix, and elements of the connection matrix are connection types of weight values of corresponding elements in the weight matrix. At least some of the connection types have a data volume smaller than the corresponding weight values, and the connection types are classified into valid connection and invalid connection.

The data type table includes data types which are sequentially arranged and correspond to weight values in the connection type of valid connection in the weight matrix. At least some of the data types have a data volume smaller than the corresponding weight values, and the data types include a special value type and a plurality of first preset value types, each first preset value type corresponds to a first preset weight value, which is a preset weight value in the connection type of valid connection, the special value type corresponds to special weight values, and other weight values in the connection type of valid connection, except the first preset weight value, belong to the special weight values.

In some possible implementations, the coding array may include a type matrix.

Determining, according to the prestored coding array and the prestored special value table, the weight value of the corresponding element in the weight matrix includes: determining, according to types of elements in a prestored type matrix, a prestored special value table and second preset weight values, the weight value of the corresponding element in the weight matrix.

The type matrix has a same structure as the weight matrix, elements of the type matrix are types of weight values of corresponding elements in the weight matrix, and at least some of the types have a data volume smaller than the corresponding weight values. The types include a special value type and a plurality of second preset value types. Each second preset value type corresponds to a second preset weight value, the special value type corresponds to special weight values, and other weight values, except the second preset weight value, belong to the special weight values.

It should be noted that the above merely describes an example of the coding array, and the coding array may also be arranged in other manners, which is not limited in the present disclosure.

The following describes a data acquisition method for a weight matrix according to embodiments of the present application in detail with reference to FIGS. 9 to 13.

FIG. 9 is a flowchart of a data acquisition method for a weight matrix according to the present disclosure. Referring to FIG. 9, the data acquisition method for a weight matrix according to the present disclosure includes operation S401.

At operation S401, determining, according to prestored connection matrix, data type table and special value table, a weight value of a corresponding element in the weight matrix.

The connection matrix has a same structure as the weight matrix, and each element of the connection matrix is a connection type of a weight value of a corresponding element in the weight matrix. One connection type has a data volume smaller than one weight value, and the connection types are classified into valid connection and invalid connection.

The data type table includes data types which are sequentially arranged and correspond to weight values in the connection type of valid connection in the weight matrix. One data type has a data volume smaller than one weight value, the data types include a special value type and a plurality of preset value types, each preset value type corresponds to a preset weight value in the connection type of valid connection, the special value type corresponds to special weight values, and other weight values in the connection type of valid connection, except the preset weight value, are the special weight values.

The special value table includes all the special weight values in the weight matrix which are sequentially arranged.

It can be seen that the data of the weight matrix stored in the above method is not the “weight matrix” itself, so when the weight value of an element in the weight matrix is desired to be used, it is firstly determined whether the weight value is in the connection type of valid connection or invalid connection according to a corresponding element (an element in a same relative position) in the connection matrix. When the weight value is in the connection type of valid connection, the data type of the weight value is further determined according to the data type table, and then it is determined which preset weight value the weight value is or which special weight value in the special value table the weight value is, that is, the weight value is obtained.

As a form of the embodiment of the present disclosure, when the weight value of an element in the weight matrix is desired to be used, the corresponding weight value can be directly obtained in the above manner, and directly read out and utilized.

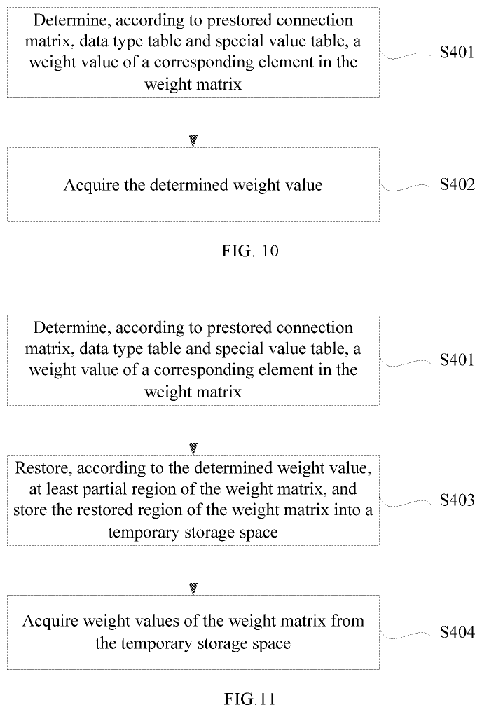

Referring to FIG. 10, in some embodiments, after determining, according to the prestored connection matrix, data type table and special value table, the weight value of the corresponding element in the weight matrix (S401), the method further includes operation S402.

At operation S402, acquiring the determined weight value.

As a form of the embodiment of the present disclosure, when the weight value of an element in the weight matrix is desired to be used, the corresponding weight value can be directly obtained in the above manner, and directly read out and utilized.

Referring to FIG. 11, in some embodiments, after determining, according to the prestored connection matrix, data type table and special value table, the weight value of the corresponding element in the weight matrix (S401), the method further includes operations S403 to S404.

At operation S403, restoring, according to the determined weight value, at least partial region of the weight matrix, and storing the restored region of the weight matrix into a temporary storage space.

At operation S404, acquiring weight values of the weight matrix from the temporary storage space.

As another form of the embodiment of the present disclosure, a part or all of the weight values in the weight matrix may be obtained first, that is, the weight matrix or a part of the weight matrix is “restored” and stored in a temporary storage space. Therefore, the temporary storage space is equivalent to a “temporary weight matrix”, from which the weight values may be obtained when needed.

When the data in the “temporary weight matrix” is used up, “another part” of the weight matrix may be written into the temporary storage space again.

The following describes an implementation of obtaining weight values of elements in the weight matrix.

It will be appreciated that there is no necessary relationship between how to obtain the weight values of the elements in the weight matrix, and how to use the weight values subsequently. For example, the weight values obtained in the following manner may be directly acquired (e.g., S402), or may be used to form the “temporary weight matrix (e.g., S403, S404)” described above.

It will be appreciated that the following implementation of obtaining elements in the weight matrix is merely exemplary, and not intended to limit the scope of the present disclosure.

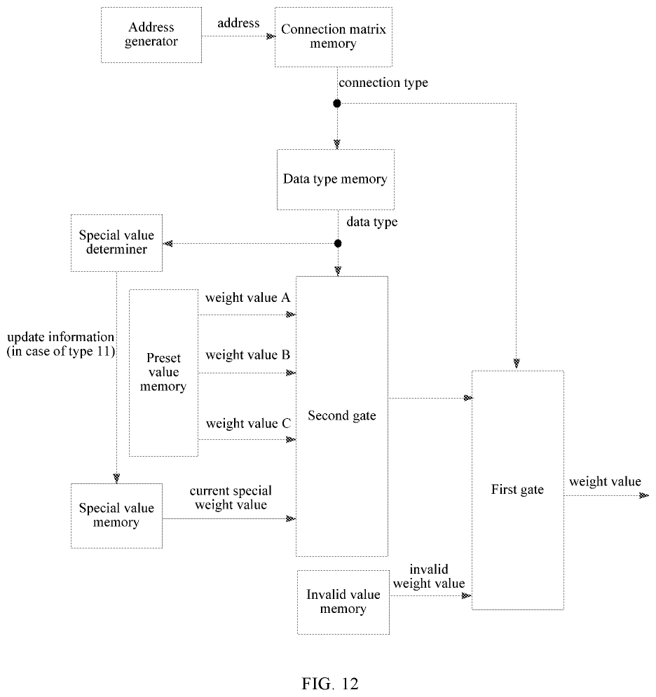

Referring to FIG. 12, in some embodiments, determining, according to the prestored connection matrix, data type table and special value table, weight values of corresponding elements in the weight matrix (S401) includes operations A1 to A9.

At operation A1, sequentially generating, by an address generator, addresses of elements in the connection matrix, and inputting the addresses to a connection matrix memory.

At operation A2, inputting, by the connection matrix memory according to the received addresses, connection types of corresponding elements in the connection matrix prestored in the connection matrix memory to a first gate and a data type memory.

At operation A3, inputting, under a condition that the data type memory receives a valid connection, a corresponding data type of a data type table prestored in the data type memory to a second gate and a special value determiner.

At operation A4, synchronously inputting, by a preset value memory, the preset weight values prestored in the preset value memory to the second gate.

At operation A5, outputting, by the special value determiner, an updating signal to a special value memory under a condition that the received data type is a special value type.

At operation A6, inputting, by the special value memory, a current special weight value in a special value table prestored in the special value memory to the second gate, and updating, upon receiving the updating signal, the current special weight value to a next special weight value in the special value table.

At operation A7, selecting, by the second gate, one of the received current special weight value or the preset weight values to output according to the received data type.

At operation A8, inputting, by an invalid value memory, an invalid weight value prestored in the invalid value memory to the first gate.

At operation A9, selecting, by the first gate, one of the received invalid weight value or an output of the second gate to output according to the received connection type.

It will be appreciated that each operation above describes merely the work or function of the corresponding structure, and therefore, the order of description of the operations above does not represent the necessary order of execution.

Referring to FIG. 12, the address generator sequentially (corresponding to the storage order of the data type table and the special value table) generates addresses and inputs the addresses to the connection matrix memory.

The generated address indicates the weight value of which element in the weight matrix is to be determined currently. Therefore, for simplicity, the addresses of the corresponding elements in the weight matrix and in the connection matrix may be the same.

According to the received addresses, the connection matrix memory inputs connection types (e.g., 1 or 0 as described above) of the element corresponding to the address to the first gate and the data type memory.

Upon receiving a connection type of “valid connection (e.g., 1)”, the data type memory inputs the corresponding data type of the data type table stored therein, i.e., a data type (e.g., 01, 10, 00 or 11 as described above) of the weight value of an address corresponding to the valid connection, to the second gate.

The data type memory may output the “corresponding” data type through various manners. For example, the data type memory may “update” the “next” data type of the output data type table each time the “valid connection” is received, so as to ensure an ordinal number of the output data type, which is equal to an ordinal number of the corresponding weight value in all the weight values in the connection type of valid connection in the weight matrix.

Upon receiving a connection type of “invalid connection (e.g., 0)”, the data type memory may or may not output the previous data type, which is not described in detail herein.

Meanwhile, the preset value memory (e.g., a register) synchronously inputs (e.g., continuously inputs) all the preset weight values (e.g., the weight value A, the weight value B, and the weight value C described above) stored therein to the second gate. The special value memory also inputs (e.g., continuously inputs) the current special weight value stored therein to the second gate.

Therefore, the second gate receives all the preset weight values and the current special weight value at the same time.

Meanwhile, the second gate further receives a data type (from the data type memory) of an element whose weight value is to be determined currently, so that the second gate can determine, according to the data type, which weight value should be output (for example, if the data type is 01, the weight value A is output, if the data type is 10, the weight value B is output, if the data type is 00, the weight value C is output, and if the data type is 11, the current special weight value is output), i.e., which “path” of input is gated. Meanwhile, other “paths” of weight values received by the second gate do not correspond to the current element and are thus not output.

The second gate may not generate any output of no data type is received.

The data type memory also inputs the data type to the special value determiner, and the special value determiner outputs an updating signal to the special value memory when the received data type is a special value type (e.g., 11), so that the special value memory can “update” the current special weight value, i.e., selects a “next” special weight value in the special value table as a new current special weight value and outputs it to the gate.

It can be seen that the addresses are generated by the address generator “in sequence”, the data types in the data type table are also arranged “in sequence” in the same manner, and the special weight values in the special value table stored in the special value memory are also arranged “in sequence” in the same manner. Therefore, the address and the current special weight value can be guaranteed to be “synchronous” by updating the current special weight value when the data type is the special value type.

Further, the invalid value memory inputs (e.g., continuously inputs) an invalid weight value (having no weight, for example, with a weight value of 0) prestored therein to the first gate. That is, the first gate receives both the invalid weight value and the output (the preset weight value or the current special weight value) of the second gate.

Therefore, the first gate may select one of the received invalid weight value or the output of the second gate to output according to the received connection type (from the connection matrix memory). Exemplarily, the invalid weight value is output when the connection type of invalid connection is received, and the output of the second gate (the preset weight values or the current special weight value) is output when the connection type of valid connection is received, thereby implementing accurate output of the invalid weight value.

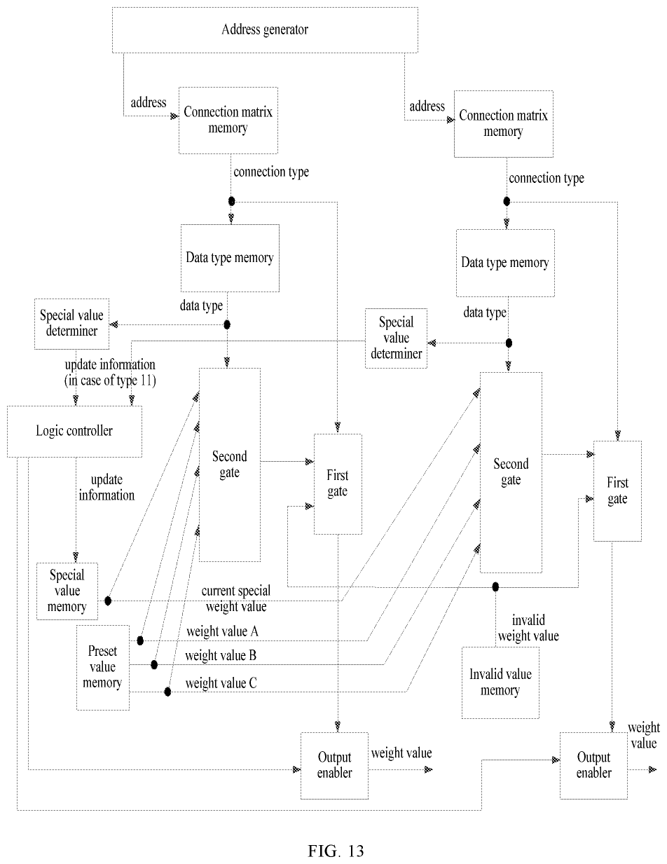

Referring to FIG. 13, in some embodiments, the data acquisition apparatus for a weight matrix includes an acquisition unit, including the connection matrix memory, the data type memory, the special value determiner, the first gate and the second gate as described above.

When a plurality of acquisition units are provided, each acquisition unit further includes: an output enabler connected to an output of the first gate.

The apparatus according to the present disclosure further includes: a logic controller connected between each special value determiner and the special value memory, and connected to each output enabler. The logic controller is configured to send an updating signal to the special value memory, and upon receiving a plurality of updating signals at the same time, sequentially input the plurality of updating signals to the special value memory, and control output enablers of acquisition units respectively corresponding to the updating signals to be sequentially turned on.

As discussed above, each acquisition unit may determine the weight value of one element, and therefore, if the weight values of a plurality of elements (for example, the weight values of a plurality of adjacent elements in a same row of the weight matrix) are to be determined simultaneously in a “parallel” manner, a plurality of (two as an example in FIG. 13) acquisition units are desired to be used simultaneously and operated synchronously, where each acquisition unit determines one weight value.

In the case of a plurality of acquisition units, when referring to interaction of two structures belonging to the acquisition unit, it should be interpreted as interaction of two structures inside a same acquisition unit, unless otherwise specified.

Referring to FIG. 13, in the case of a plurality of acquisition units, the special value memory, the preset value memory, and the invalid value memory may be “common”, that is, these memories synchronously output the current special weight value and the preset weight value to the second gates of all acquisition units, and output the invalid weight value to the first gates of all acquisition units, thereby simplifying the hardware configuration.

The address generator is also “common”, except that addresses of elements to be processed by the acquisition units are input to the connection matrix memories of the corresponding acquisition units, respectively (i.e., different addresses are input to different connection matrix memories at the same time, and are arranged in sequence), and then the connection matrix memory of each acquisition unit inputs the corresponding connection type to the first gate and the data type memory of the acquisition unit, so that the first gate outputs the weight value of the corresponding element.

When the weight values of the plurality of elements output “in parallel” include a plurality of special weight values, the second gates of a plurality of acquisition units will receive a data type being the special value type, and the current special weight values are respectively output to the corresponding first gates. However, the special weight values to be output by the plurality of different acquisition units (through the first gates) are actually different, i.e., the special value memory is desired to update the current special weight value for several times.

To this end, referring to FIG. 13, a logic controller and an output enabler are further provided.

If the logic controller receives merely one updating signal at the same time, the updating signal is directly forwarded to the special value memory.

However, when the weight values of the plurality of elements output “in parallel” include a plurality of special weight values, the logic controller will receive a plurality of (e.g., two) updating signals at the same time, so the updating signals are input to the special value memory in sequence (e.g., a first updating signal is input to the special value memory firstly, and then a second updating signal is input to the special value memory after a certain period of time). Furthermore, the special value memory will update the current special weight value for multiple times, and output different current special weight values at different times (for example, after receiving the first updating signal and before the second updating signal, a first current special weight value is output; and after receiving the second updating signal, a second current special weight value is output).

Accordingly, upon receiving a plurality of updating signals at the same time, the logic controller further controls the output enablers of the acquisition units corresponding to the updating signals to be sequentially turned on in a polling mode (for example, when the special value memory outputs the first current special weight value, the output enabler of the acquisition unit corresponding to the first updating signal is turned on, and the output enabler of the acquisition unit corresponding to the second updating signal is turned off; and when the special value memory outputs the second current special weight value, the output enabler of the acquisition unit corresponding to the second updating signal is turned on, and the output enabler of the acquisition unit corresponding to the first updating signal is turned off).

In this manner, the plurality of acquisition units corresponding to the respective updating signals can output (“in parallel”, but not completely “simultaneously”) the special weight values of the respective corresponding elements.

Upon receiving the plurality of updating signals at the same time, the logic controller controls the output enablers of other acquisition units not corresponding to the updating signals to maintain an on state; and when merely one updating signal is received at the same time or no updating signal is received, the logic controller controls the output enablers of all the acquisition units to maintain an on state, which is not described in detail herein.

The logic controller may be implemented in various manners. For example, the logic controller may implement metronomic adjustment of the operating state by a multiply accumulator, which is not described in detail herein.

As described above, in some possible implementations, the coding array may include a type matrix.

The following describes a data acquisition method for a weight matrix according to embodiments of the present application in detail with reference to FIGS. 14 to 18.

FIG. 14 is a flowchart of a data acquisition method for a weight matrix according to the present disclosure. Referring to FIG. 14, the data acquisition method for a weight matrix according to the present disclosure includes operation S501.

At operation S501, determining, according to types of elements of a prestored type matrix, a prestored special value table and preset weight values, a weight value of a corresponding element in the weight matrix.

The type matrix has a same structure as the weight matrix, each element of the type matrix is a type corresponding to a weight value of a corresponding element in the weight matrix, and one type has a data volume smaller than one weight value. The types include a special value type and a plurality of preset value types. Each preset value type corresponds to one preset weight value, the special value type corresponds to special weight values, and other weight values, except the preset weight value, are the special weight values. The special value table includes all the special weight values in the weight matrix which are sequentially arranged.

It can be seen that the data of the weight matrix stored in the above method is not the “weight matrix” itself, so when the weight value of an element in the weight matrix is desired to be used, the corresponding type of weight value is firstly determined according to a type of a corresponding element (an element in a same relative position) in the type matrix, and then the corresponding special weight value or preset weight value is determined according to the special value table and the preset weight values.

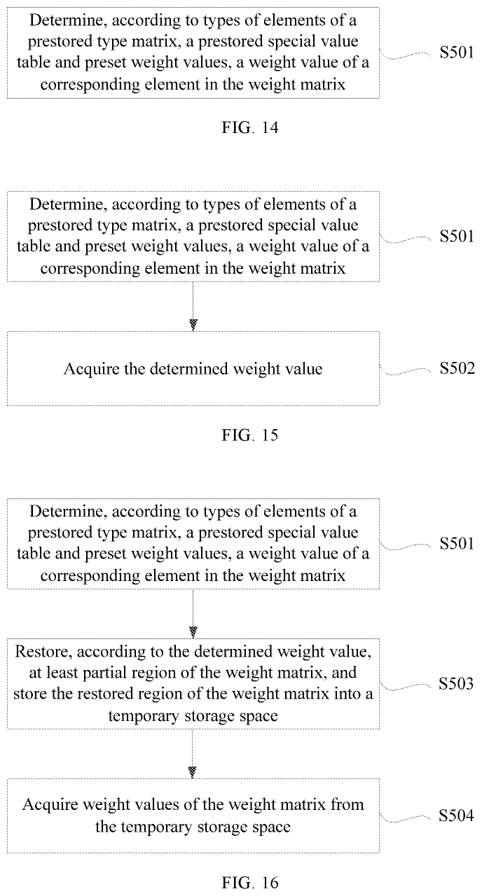

Referring to FIG. 15, in some embodiments, after determining, according to the types of elements of the prestored type matrix, and the prestored special value table and the preset weight values, the weight value of the corresponding element in the weight matrix (S501), the method further includes operation S502.

At operation S502, acquiring the determined weight value.

As a form of the embodiment of the present disclosure, when the weight value of an element in the weight matrix is desired to be used, the corresponding weight value can be directly obtained in the above manner, and directly read out and utilized.

Referring to FIG. 16, in some embodiments, after determining, according to the types of elements of the prestored type matrix, and the prestored special value table and the preset weight values, the weight value of the corresponding element in the weight matrix (S501), the method further includes operations S503 to S504.

At operation S503, restoring, according to the determined weight value, at least partial region of the weight matrix, and storing the restored region of the weight matrix into a temporary storage space.

At operation S504, acquiring weight values of the weight matrix from the temporary storage space.

As another form of the embodiment of the present disclosure, a part or all of the weight values in the weight matrix may be obtained first, that is, the weight matrix or a part of the weight matrix is “restored” and stored in a temporary storage space. Therefore, the temporary storage space is equivalent to a “temporary weight matrix”, from which the weight values may be obtained when needed.

When the data in the “temporary weight matrix” is used up, “another part” of the weight matrix may be written into the temporary storage space again.

The following describes an implementation of obtaining weight values of elements in the weight matrix.

It will be appreciated that there is no necessary relationship between how to obtain the weight values of the elements in the weight matrix, and how to use the weight values subsequently. For example, the weight values obtained in the following manner may be directly acquired (e.g., S502), or may be used to form the “temporary weight matrix (e.g., S503, S504)” described above.

It will be appreciated that the following implementation of obtaining elements in the weight matrix is merely exemplary, and not intended to limit the scope of the present disclosure.

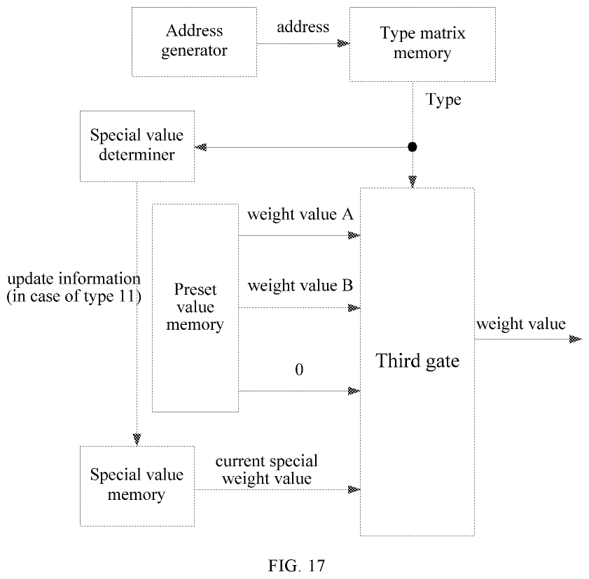

Referring to FIG. 17, in some embodiments, determining, according to the types of elements of the prestored type matrix, and the prestored special value table and the preset weight values, the weight value of the corresponding element in the weight matrix (S501), includes the following operations B1 to B6.

At operation B1, sequentially generating, by an address generator, addresses of elements in the type matrix, and inputting the addresses to a type matrix memory.

At operation B2, synchronously inputting, by a preset value memory, the preset weight values prestored in the preset value memory to a third gate.

At operation B3, inputting, by the type matrix memory according to the received addresses, types of corresponding elements in the type matrix prestored in the type matrix memory to the third gate and a special value determiner.

At operation B4, outputting, by the special value determiner, an updating signal to a special value memory under a condition that the received type is a special value type.

At operation B5, inputting, by the special value memory, a current special weight value in a special value table prestored in the special value memory to the third gate, and updating, upon receiving the updating signal, the current special weight value to a next special weight value in the special value table.

At operation B6, selecting, by the third gate, one of the received current special weight value or the preset weight values to output according to the received type.

It will be appreciated that each operation above describes merely the work or function of the corresponding structure, and therefore, the order of description of the operations above does not represent the necessary order of execution.

Referring to FIG. 17, the address generator sequentially (corresponding to the storage order of special weight values in the special value table) generates addresses and inputs the addresses to the type matrix memory.

The generated address indicates the weight value of which element in the weight matrix is to be determined currently. Therefore, for simplicity, the addresses of the corresponding elements in the weight matrix and in the type matrix may be the same.

According to the received addresses, the type matrix memory inputs the types (e.g., 01, 10, 00 or 11 as described above) of the element indicated by the address to the third gate.

Meanwhile, the preset value memory (e.g., a register) synchronously inputs (e.g., continuously inputs) all the preset weight values (e.g., the weight value A, the weight value B, and 0 described above) stored therein to the third gate. The special value memory also inputs (e.g., continuously inputs) the current special weight value stored therein to the third gate.

Therefore, the third gate receives all the preset weight values and the current special weight value at the same time. Meanwhile, the third gate further receives a type of an element whose weight value is to be determined currently, so that the third gate can determine, according to the type, which weight value should be output (for example, if the type is 01, the weight value A is output, if the type is 10, the weight value B is output, if the type is 00, 0 is output, and if the type is 11, the current special weight value is output), i.e., which “path” of input is gated and output as the weight value of the current element. Meanwhile, other “paths” of weight values received by the third gate do not correspond to the current element and are thus not output.

The type matrix memory also inputs the type to the special value determiner, and the special value determiner outputs an updating signal to the special value memory when the received type is the special value type (e.g., 11), so that the special value memory can “update” the current special weight value, i.e., selects a “next” special weight value in the special value table as a new current special weight value and outputs it to the third gate.

It can be seen that the addresses are generated by the address generator “in sequence”, while the special weight values in the special value table stored in the special value memory are also arranged “in sequence” in the same manner. Therefore, the address and the current special weight value can be guaranteed to be “synchronous” by updating the current special weight value when the type is the special value type. That is, the output special weight value is ensured to be the special weight value actually corresponding to the current element.

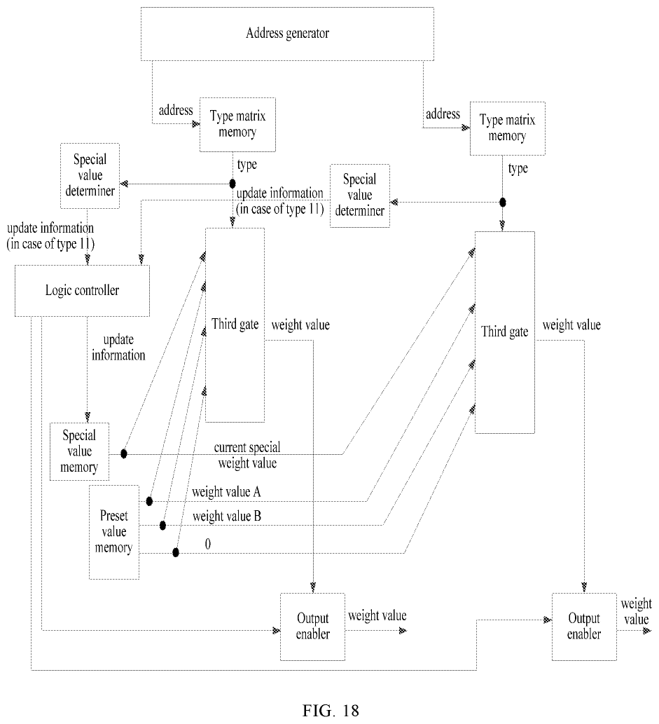

Referring to FIG. 18, in some embodiments, the data acquisition apparatus for a weight matrix includes an acquisition unit, including the type matrix memory, the special value determiner, and the third gate as described above.

When a plurality of acquisition units are provided, each acquisition unit further includes: an output enabler connected to an output of the third gate; and the data acquisition apparatus for a weight matrix further includes: a logic controller connected between each special value determiner and the special value memory, and connected to each output enabler. The logic controller is configured to send an updating signal to the special value memory, and upon receiving a plurality of updating signals at the same time, sequentially input the plurality of updating signals to the special value memory, and control output enablers of acquisition units respectively corresponding to the updating signals to be sequentially turned on.

As discussed above, each acquisition unit may determine the weight value of one element, and therefore, if the weight values of a plurality of elements (for example, the weight values of a plurality of adjacent elements in a same row of the weight matrix) are to be determined simultaneously in a “parallel” manner, a plurality of (two as an example in FIG. 18) acquisition units are desired to be used simultaneously and operated synchronously, where each acquisition unit determines one weight value.

In the case of a plurality of acquisition units, when referring to interaction of two structures belonging to the acquisition unit, it should be interpreted as interaction of two structures inside a same acquisition unit, unless otherwise specified.

Referring to FIG. 18, in the case of a plurality of acquisition units, the special value memory and the preset value memory may be “common”, that is, these memories synchronously output the current special weight value and the preset weight value to the third gates of all acquisition units, thereby simplifying the hardware configuration.

The address generator is also “common”, except that addresses of elements to be processed by the acquisition units are input to the type matrix memory of the corresponding acquisition units, respectively (i.e., different addresses are input to different type matrix memories at the same time, and are arranged in sequence), and then the type matrix memory of each acquisition unit inputs the corresponding type to the third gate of the acquisition unit, so that the third gate outputs the weight value of the corresponding element.

When the weight values of the plurality of elements output “in parallel” include a plurality of special weight values, the third gates of a plurality of acquisition units will receive a type being the special value type, and output the current special weight values, respectively. However, the special weight values to be output by the plurality of different acquisition units are actually different, i.e., the special value memory is desired to update the current special weight value for several times.

To this end, referring to FIG. 18, a logic controller and an output enabler are further provided.

If the logic controller receives merely one updating signal at the same time, the updating signal is directly forwarded to the special value memory.

However, when the weight values of the plurality of elements output “in parallel” include a plurality of special weight values, the logic controller will receive a plurality of (e.g., two) updating signals at the same time, so the updating signals are input to the special value memory in sequence (e.g., a first updating signal is input to the special value memory firstly, and then a second updating signal is input to the special value memory after a certain period of time). Furthermore, the special value memory will update the current special weight value for multiple times, and output different current special weight values at different times (for example, after receiving the first updating signal and before the second updating signal, a first current special weight value is output; and after receiving the second updating signal, a second current special weight value is output).

Accordingly, upon receiving a plurality of updating signals at the same time, the logic controller further controls the output enablers of the acquisition units corresponding to the updating signals to be sequentially turned on in a polling mode (for example, when the special value memory outputs the first current special weight value, the output enabler of the acquisition unit corresponding to the first updating signal is turned on, and the output enabler of the acquisition unit corresponding to the second updating signal is turned off; and when the special value memory outputs the second current special weight value, the output enabler of the acquisition unit corresponding to the second updating signal is turned on, and the output enabler of the acquisition unit corresponding to the first updating signal is turned off).

In this manner, the plurality of acquisition units corresponding to the respective updating signals can output (“in parallel”, but not completely “simultaneously”) the special weight values of the respective corresponding elements.

Upon receiving the plurality of updating signals at the same time, the logic controller controls the output enablers of other acquisition units not corresponding to the updating signals to maintain an on state; and when merely one updating signal is received at the same time or no updating signal is received, the logic controller controls the output enablers of all the acquisition units to maintain an on state, which is not described in detail herein.

The logic controller may be implemented in various manners. For example, the logic controller may implement metronomic adjustment of the operating state by a multiply accumulator, which is not described in detail herein.

In a third aspect, the present disclosure provides a data acquisition apparatus for a weight matrix.

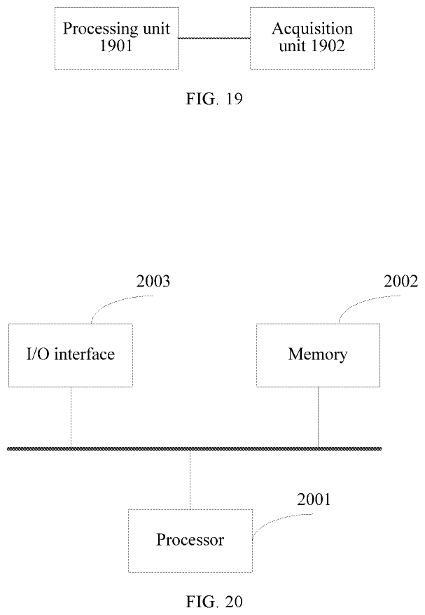

FIG. 19 is a block diagram of a data acquisition apparatus for a weight matrix according to the present disclosure. Referring to FIG. 19, the data acquisition apparatus according to the present disclosure includes: a processing unit 1901 and at least one acquisition unit 1902.

The processing unit 1901 is configured to determine, according to a prestored coding array and a prestored special value table, a weight value of a corresponding element in the weight matrix; and the acquisition unit 1902 is configured to acquire the determined weight value.

The coding array and the special value table occupy a storage space smaller than the weight matrix. The special value table includes all special weight values in the weight matrix which are sequentially arranged.

Exemplarily, referring to FIG. 12, a data acquisition apparatus for a weight matrix according to the present disclosure is shown, including an address generator, a special value memory, an invalid value memory, a preset value memory, and at least one acquisition unit.

The address generator is configured to sequentially generate addresses of elements in a connection matrix, and input the addresses to a connection matrix memory of a corresponding acquisition unit. The preset value memory is configured to store all preset weight values, and synchronously input the preset weight values to second gates of all acquisition units. The invalid value memory is configured to store an invalid weight value, and input the invalid weight value to first gates of all the acquisition units. The special value memory is configured to store a special value table, input a current special weight value in the special value table to the second gates, and update, upon receiving an updating signal, the current special weight value to a next special weight value in the special value table.

Each acquisition unit includes: the connection matrix memory configured to store the connection matrix, and input, according to the received addresses, connection types of corresponding elements in the prestored connection matrix to the first gate and a data type memory; the data type memory configured to input, upon receiving a valid connection, a corresponding data type of the data type table prestored in the data type memory to the second gate and a special value determiner; the special value determiner configured to output an updating signal to the special value memory upon receiving a data type being a special value type; the second gate configured to select one of the received current special weight value or the preset weight values to output according to the received data type; and the first gate configured to select one of the received invalid weight value or an output of the second gate to output according to the received connection type.

The connection matrix has a same structure as the weight matrix, and each element of the connection matrix is a connection type of a weight value of a corresponding element in the weight matrix. One connection type has a data volume smaller than one weight value, and the connection types are classified into valid connection and invalid connection. The data type table includes data types which are sequentially arranged and correspond to weight values in the connection type of valid connection in the weight matrix. One data type has a data volume smaller than one weight value, the data types include a special value type and a plurality of preset value types, each preset value type corresponds to a preset weight value in the connection type of valid connection, the special value type corresponds to special weight values, and other weight values in the connection type of valid connection, except the preset weight value, are the special weight values. The special value table includes all the special weight values in the weight matrix which are sequentially arranged.

Exemplarily, referring to FIG. 13, in some embodiments, a plurality of acquisition units are provided.

Each acquisition unit further includes: an output enabler connected to an output of the first gate.

The apparatus further includes: a logic controller connected between each special value determiner and the special value memory, and connected to each output enabler. The logic controller is configured to send an updating signal to the special value memory, and upon receiving a plurality of updating signals at the same time, sequentially input the plurality of updating signals to the special value memory, and control output enablers of acquisition units corresponding to the updating signals to be sequentially turned on.

The apparatus according to the present disclosure may implement the above data acquisition method for a weight matrix through the above hardware structure, which is not described in detail herein.

In the case of a plurality of acquisition units, when referring to interaction of two structures belonging to the acquisition unit, it should be interpreted as interaction of two structures inside a same acquisition unit, unless otherwise specified.

The plurality of structures in the apparatus may be multiple independent physical devices, or multiple structures integrated into and implemented by one physical device, which are not described in detail herein.

Exemplarily, referring to FIG. 17, a data acquisition apparatus for a weight matrix according to the present disclosure is shown, including an address generator, a special value memory, a preset value memory, and at least one acquisition unit.

The address generator is configured to sequentially generate addresses of elements in a type matrix, and input the addresses to a type matrix memory of a corresponding acquisition unit. The preset value memory is configured to store all preset weight values, and synchronously input the preset weight values to third gates of all acquisition units. The special value memory is configured to store a special value table, input a current special weight value in the special value table to the third gates, and update, upon receiving an updating signal, the current special weight value to a next special weight value in the special value table.

Each acquisition unit includes: the type matrix memory configured to store the type matrix, and input, according to the received addresses, types of corresponding elements in the type matrix to the third gate and a special value determiner; the special value determiner configured to output an updating signal to the special value memory upon receiving a type being a special value type; and the third gate configured to select one of the received current special weight value or the preset weight values to output according to the received type.

The type matrix has a same structure as the weight matrix, each element of the type matrix is a type corresponding to a weight value of a corresponding element in the weight matrix, and one type has a data volume smaller than one weight value. The types include a special value type and a plurality of preset value types. Each preset value type corresponds to one preset weight value, the special value type corresponds to special weight values, and other weight values, except the preset weight value, are the special weight values. The special value table includes all the special weight values in the weight matrix which are sequentially arranged.

Exemplarily, referring to FIG. 18, in some embodiments, a plurality of acquisition units are provided.

Each acquisition unit further includes: an output enabler connected to an output of the third gate.

The apparatus further includes: a logic controller connected between each special value determiner and the special value memory, and connected to each output enabler. The logic controller is configured to send an updating signal to the special value memory, and upon receiving a plurality of updating signals at the same time, sequentially input the plurality of updating signals to the special value memory, and control output enablers of acquisition units corresponding to the updating signals to be sequentially turned on.

The apparatus according to the present disclosure may implement the above data acquisition method for a weight matrix through the above hardware structure, which is not described in detail herein.

In the case of a plurality of acquisition units, when referring to interaction of two structures belonging to the acquisition unit, it should be interpreted as interaction of two structures inside a same acquisition unit, unless otherwise specified.

The plurality of structures in the apparatus may be multiple independent physical devices, or multiple structures integrated into and implemented by one physical device, which are not described in detail herein.

FIG. 20 is a block diagram of an electronic device provided in the present disclosure.

Referring to FIG. 20, the present disclosure provides an electronic device, including: at least one processor 2001; at least one memory 2002, and one or more I/O interfaces 2003 connected between the processor 2001 and the memory 2002. The memory 2002 has one or more computer programs stored thereon, which may be executed by the at least one processor 2001, where the one or more computer programs, when executed by the at least one processor 2001, causes the at least one processor 2001 to implement the data storage method for a weight matrix or the data acquisition method for a weight matrix as described above.

The present disclosure further provides a computer-readable storage medium having a computer program stored thereon which, when executed by a processor/processing core, causes the data storage method for a weight matrix or the data acquisition method for a weight matrix as described above to be implemented. The computer-readable storage medium may be a volatile or nonvolatile computer-readable storage medium.

The present disclosure further provides a computer program product including a computer-readable code, or a nonvolatile computer-readable storage medium having a computer-readable code stored thereon, where the computer-readable code, when executed on a processor of an electronic device, causes the processor in the electronic device to implement the data storage method for a weight matrix or the data acquisition method for a weight matrix as described above.

Those of ordinary skill in the art will appreciate that all or some operations of the above described method, functional modules/units in the system and apparatus may be implemented as software, firmware, hardware, and suitable combinations thereof. In a hardware implementation, the division between the functional modules/units mentioned in the above description does not necessarily correspond to the division of physical components; for example, one physical component may have multiple functions, or one function or operation may be performed cooperatively by several physical components. Some or all physical components may be implemented as software executed by a processor, such as a CPU, a digital signal processor or microprocessor, or implemented as hardware, or implemented as an integrated circuit, such as an application specific integrated circuit. Such software may be distributed on a computer-readable storage medium which may include a computer storage medium (or non-transitory medium) or a communication medium (or transitory medium).

As is well known to those of ordinary skill in the art, the term computer storage medium includes volatile and nonvolatile, removable and non-removable medium implemented in any method or technology for storing information, such as computer-readable program instructions, data structures, program modules or other data. The computer storage medium includes, but is not limited to, a random access memory (RAM), read-only memory (ROM), an erasable programmable read-only memory (EPROM), a static random access memory (SRAM), a flash memory or any other memory technology, a portable compact disc read-only memory (CD-ROM), a digital versatile disk (DVD) or any other optical disk storage device, a magnetic cassette, a magnetic tape, a magnetic disk storage means or any other magnetic storage device, or any other medium which can be used to store the desired information and accessed by a computer. Moreover, it is well known to those ordinary skilled in the art that a communication medium typically includes computer-readable program instructions, a data structure, a program module, or other data in a modulated data signal, such as a carrier wave or other transport mechanism, and may include any information delivery medium.

The computer-readable program instructions described herein can be downloaded to respective computing/processing devices from a computer-readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer program instructions for carrying out operations of the present disclosure may be assembler instructions, instruction set architecture (ISA) instructions, machine instructions, machine-related instructions, microcodes, firmware instructions, state setting data, or source or object codes written in any combination of one or more programming languages, including an object oriented programming language such as Smalltalk, C++, or the like, and procedural programming languages, such as the “C” programming language or similar programming languages. The computer-readable program instructions may execute entirely on the user computer, partly on the user computer, as a stand-alone software package, partly on the user computer and partly on a remote computer or entirely on the remote computer or server. In the latter scenario, the remote computer may be connected to the user computer through any type of network, including a local area network (LAN) or a wide area network (WAN), or by connecting to an external computer (for example, through the Internet provided by an Internet service provider). In some embodiments, aspects of the present disclosure are implemented by personalizing an electronic circuit, such as a programmable logic circuit, a field programmable gate array (FPGA), or a programmable logic array (PLA), with state information of computer-readable program instructions, which can execute the computer-readable program instructions.

The computer program product described herein may be implemented in hardware, software, or a combination thereof In an optional embodiment, the computer program product is exemplarily embodied in a computer storage medium, while in another optional embodiment, the computer program product is exemplarily embodied in a software product, such as a software development kit (SDK) or the like.

Aspects of the present disclosure are described herein with reference to flowchart illustrations and/or block diagrams of methods, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general purpose computer, special purpose computer, or other programmable data processing apparatus to produce a machine, such that the instructions, when executed via the processor of the computer or other programmable data processing apparatus, create means for implementing the functions/acts specified in flowchart and/or block diagram block or blocks. These computer-readable program instructions may also be stored in a computer-readable storage medium, and direct a computer, a programmable data processing apparatus, and/or other devices to function in a particular manner, such that the computer-readable medium having the instructions stored therein includes an article of manufacture including instructions for implementing aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable data processing apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagram may represent a functional block, a program segment, or a portion of instructions including one or more executable instructions for implementing the specified logical function(s). In some alternative implementations, the functions shown in the blocks may occur out of the order shown in the figures. For example, two blocks shown in succession may, in fact, be executed substantially concurrently, or may sometimes be executed in the reverse order, depending upon the functionality involved. It will also be noted that each block in the block diagram and/or flowchart, and combinations of blocks in the block diagram and/or flowchart, may be implemented by a special purpose hardware-based system which performs the specified functions or acts, or by combinations of special purpose hardware and computer instructions.

The present disclosure has disclosed example embodiments, and although terms are employed, they are used and should be interpreted merely in a generic and descriptive sense, not for purposes of limitation. In some instances, as would be apparent to one skilled in the art, features, characteristics and/or elements described in connection with a particular embodiment may be used alone or in combination with features, characteristics and/or elements described in connection with another embodiment, unless expressly stated otherwise. It will, therefore, be understood by those skilled in the art that various changes in form and details may be made therein without departing from the scope of the present disclosure as set forth in the appended claims.

1. A data storage method for a weight matrix, comprising:
generating a coding array and a special value table according to the weight matrix; and
storing the coding array and the special value table,
wherein the coding array and the special value table occupy a storage space smaller than the weight matrix, and the special value table comprises all special weight values in the weight matrix which are sequentially arranged.

2. The method according to claim 1, wherein the coding array comprises a connection matrix and a data type table,
wherein the connection matrix has a same structure as the weight matrix, and elements of the connection matrix are connection types of weight values of corresponding elements in the weight matrix, at least some of the connection types have a data volume smaller than the corresponding weight values, and the connection types are classified into valid connection and invalid connection,
the data type table comprises data types which are sequentially arranged and correspond to weight values in the connection type of valid connection in the weight matrix, at least some of the data types have a data volume smaller than the corresponding weight values, and the data types comprise a special value type and a plurality of first preset value types, each first preset value type corresponds to a first preset weight value, which is a preset weight value in the connection type of valid connection, the special value type corresponds to the special weight values, and other weight values in the connection type of valid connection, except the first preset weight value, belong to the special weight values.

3. The method according to claim 2, wherein before generating the coding array and the special value table according to the weight matrix, the method further comprises:
determining, according to the weight matrix, a plurality of weight values in the connection type of valid connection in the weight matrix as the first preset weight values, and storing the first preset weight value.

4. (canceled)

5. The method according to claim 1, wherein the coding array comprises a type matrix, and
wherein the type matrix has a same structure as the weight matrix, and elements of the type matrix are types of weight values of corresponding elements in the weight matrix, at least some of the types have a data volume smaller than the corresponding weight values, the types comprise a special value type and a plurality of second preset value types, each second preset value type corresponds to a second preset weight value, the special value type corresponds to the special weight values, and other weight values, except the second preset weight value, belong to the special weight values.

6. (canceled)

7. The method according to claim 5, wherein before generating the coding array and the special value table according to the weight matrix, the method further comprises:
determining, according to the weight matrix, a plurality of weight values in the weight matrix as the second preset weight value, and storing the second preset weight value.

8. A data acquisition method for a weight matrix, comprising:
determining, according to a prestored coding array and a prestored special value table, a weight value of a corresponding element in the weight matrix; and
acquiring the determined weight value,
wherein the coding array and the special value table occupy a storage space smaller than the weight matrix, and the special value table comprises all special weight values in the weight matrix which are sequentially arranged.

9. The method according to claim 8, wherein the coding array comprises a connection matrix and a data type table,
wherein the connection matrix has a same structure as the weight matrix, and elements of the connection matrix are connection types of weight values of corresponding elements in the weight matrix, at least some of the connection types have a data volume smaller than the corresponding weight values, and the connection types are classified into valid connection and invalid connection,
the data type table comprises data types which are sequentially arranged and correspond to weight values in the connection type of valid connection in the weight matrix, at least some of the data types have a data volume smaller than the corresponding weight values, and the data types comprise a special value type and a plurality of first preset value types, each first preset value type corresponds to a first preset weight value, which is a preset weight value in the connection type of valid connection, the special value type corresponds to the special weight values, and other weight values in the connection type of valid connection, except the first preset weight value, belong to the special weight values.

10. The method according to claim 9, wherein determining, according to the prestored coding array and the prestored special value table, the weight value of the corresponding element in the weight matrix comprises:
sequentially generating, by an address generator, addresses of elements in the connection matrix, and inputting the addresses to a connection matrix memory;
inputting, by the connection matrix memory according to the received addresses, connection types of corresponding elements in the connection matrix prestored in the connection matrix memory to a first gate and a data type memory;
inputting, under a condition that the data type memory receives a valid connection, a corresponding data type of a data type table prestored in the data type memory to a second gate and a special value determiner;
synchronously inputting, by a preset value memory, the first preset weight value prestored in the preset value memory to the second gate;
outputting, by the special value determiner, an updating signal to a special value memory under a condition that the received data type is a special value type;
inputting, by the special value memory, a current special weight value in a special value table prestored in the special value memory to the second gate, and updating, upon receiving the updating signal, the current special weight value to a next special weight value in the special value table;
selecting, by the second gate, one of the received current special weight value or the first preset weight value to output according to the received data type;
inputting, by an invalid value memory, an invalid weight value prestored in the invalid value memory to the first gate; and
selecting, by the first gate, one of the received invalid weight value or an output of the second gate to output according to the received connection type.

11. The method according to claim 8, wherein the coding array comprises a type matrix, and
determining, according to the prestored coding array and the prestored special value table, the weight value of the corresponding element in the weight matrix comprises:
determining, according to types of elements in the prestored type matrix, the prestored special value table and the second preset weight value, the weight value of the corresponding element in the weight matrix,
wherein the type matrix has a same structure as the weight matrix, and elements of the type matrix are types of weight values of corresponding elements in the weight matrix, at least some of the types have a data volume smaller than the corresponding weight values, the types comprise a special value type and a plurality of second preset value types, each second preset value type corresponds to a second preset weight value, the special value type corresponds to the special weight values, and other weight values, except the second preset weight value, belong to the special weight values.

12. The method according to claim 11, wherein determining, according to the types of the elements in the prestored type matrix, the prestored special value table and the second preset weight value, the weight value of the corresponding element in the weight matrix comprises:
sequentially generating, by an address generator, addresses of elements in the type matrix, and inputting the addresses to a type matrix memory;
inputting, by the type matrix memory according to the received addresses, types of corresponding elements in the type matrix prestored in the type matrix memory to a third gate and a special value determiner;
synchronously inputting, by a preset value memory, the second preset weight value prestored in the preset value memory to the third gate;
outputting, by the special value determiner, an updating signal to a special value memory under a condition that the received type is a special value type;
inputting, by the special value memory, a current special weight value in a special value table prestored in the special value memory to the third gate, and updating, upon receiving the updating signal, the current special weight value to a next special weight value in the special value table; and
selecting, by the third gate, one of the received current special weight value or the second preset weight value to output according to the received type.

13. The method according to claim 8, wherein after determining, according to the prestored coding array and the prestored special value table, the weight value of the corresponding element in the weight matrix, the method further comprises:
restoring, according to the determined weight value, at least partial region of the weight matrix, and storing the restored region of the weight matrix into a temporary storage space; and
acquiring weight values in the weight matrix from the temporary storage space.

14. A data acquisition apparatus for a weight matrix, comprising a processing unit and at least one acquisition unit, wherein
the processing unit is configured to determine, according to a prestored coding array and a prestored special value table, a weight value of a corresponding element in the weight matrix, and
the acquisition unit is configured to acquire the determined weight value,
wherein the coding array and the special value table occupy a storage space smaller than the weight matrix, and the special value table comprises all special weight values in the weight matrix which are sequentially arranged.

15. The apparatus according to claim 14, wherein the coding array comprises a connection matrix and a data type table, and the processing unit comprises: an address generator, a special value memory, an invalid value memory, and a first preset value memory, wherein
the connection matrix has a same structure as the weight matrix, and elements of the connection matrix are connection types of weight values of corresponding elements in the weight matrix, at least some of the connection types have a data volume smaller than the corresponding weight values, and the connection types are classified into valid connection and invalid connection,
the data type table comprises data types which are sequentially arranged and correspond to weight values in the connection type of valid connection in the weight matrix, at least some of the data types have a data volume smaller than the corresponding weight values, and the data types comprise a special value type and a plurality of first preset value types, each first preset value type corresponds to a first preset weight value, which is a preset weight value in the connection type of valid connection, the special value type corresponds to the special weight values, and other weight values in the connection type of valid connection, except the first preset weight value, belong to the special weight values,
the address generator is configured to sequentially generate addresses of elements in the connection matrix, and input the addresses to a connection matrix memory of a corresponding acquisition unit,
the first preset value memory is configured to store the first preset weight value, and synchronously input the first preset weight value to a second gate of the acquisition unit,
the invalid value memory is configured to store an invalid weight value and input the invalid weight value to a first gate of the acquisition unit,
the special value memory is configured to store the special value table, input a current special weight value in the special value table to the second gate, and update, upon receiving an updating signal, the current special weight value to a next special weight value in the special value table, and
the acquisition unit comprises:
the connection matrix memory configured to store the connection matrix and input, according to the received addresses, connection types of corresponding elements in the connection matrix to the first gate and a data type memory;
the data type memory configured to input, upon receiving a valid connection, a corresponding data type of the data type table prestored in the data type memory to the second gate and a special value determiner;
the special value determiner configured to output an updating signal to the special value memory upon receiving a data type being a special value type;
the second gate configured to select one of the received current special weight value or the first preset weight value to output according to the received data type; and
the first gate configured to select one of the received invalid weight value or an output of the second gate to output according to the received connection type.

16. The apparatus according to claim 14, wherein the coding array comprises a type matrix, and
the processing unit comprises: an address generator, a special value memory, and a second preset value memory, wherein
the type matrix has a same structure as the weight matrix, and elements of the type matrix are types of weight values of corresponding elements in the weight matrix, at least some of the types have a data volume smaller than the corresponding weight values, the types comprise a special value type and a plurality of second preset value types, each second preset value type corresponds to a second preset weight value, the special value type corresponds to the special weight values, and other weight values, except the second preset weight value, belong to the special weight values,
the address generator is configured to sequentially generate addresses of elements in the type matrix, and input the addresses to a type matrix memory of a corresponding acquisition unit;
the second preset value memory is configured to store the second preset weight value, and synchronously input the second preset weight value to a third gate of the acquisition unit;
the special value memory is configured to store the special value table, input a current special weight value in the special value table to the third gate, and update, upon receiving an updating signal, the current special weight value to a next special weight value in the special value table, and
the acquisition unit comprises:
the type matrix memory configured to store the type matrix, and input, according to the received addresses, types of corresponding elements in the type matrix to the third gate and a special value determiner;
the special value determiner configured to output an updating signal to the special value memory upon receiving a type being a special value type; and
the third gate configured to select one of the received current special weight value or the second preset weight value to output according to the received type.

17. The apparatus according to claim 15, wherein a plurality of acquisition units are provided,
the acquisition unit further comprises: an output enabler connected to an output of the first gate or an output of the third gate;
the apparatus further comprises: a logic controller connected between the special value determiner and the special value memory, and connected to the output enabler, and the logic controller is configured to send an updating signal to the special value memory, and upon receiving a plurality of updating signals at the same time, sequentially input the plurality of updating signals to the special value memory, and control output enablers of acquisition units corresponding to the updating signals to be sequentially turned on.

18. An electronic device, comprising a memory, a processor, and a computer program stored in the memory and executable on the processor, wherein the processor, when executing the computer program, implements the data storage method for a weight matrix according to claim 1.

19. A non-transitory computer-readable storage medium having a computer program stored thereon, wherein the computer program, when executed by a processor, causes the processor to implement the data storage method for a weight matrix according to claim 1.

20. (canceled)

21. The apparatus according to claim 16, wherein a plurality of acquisition units are provided,
the acquisition unit further comprises: an output enabler connected to an output of the first gate or an output of the third gate;
the apparatus further comprises: a logic controller connected between the special value determiner and the special value memory, and connected to the output enabler, and the logic controller is configured to send an updating signal to the special value memory, and upon receiving a plurality of updating signals at the same time, sequentially input the plurality of updating signals to the special value memory, and control output enablers of acquisition units corresponding to the updating signals to be sequentially turned on.

22. An electronic device, comprising a memory, a processor, and a computer program stored in the memory and executable on the processor, wherein the processor, when executing the computer program, implements the data acquisition method for a weight matrix according to claim 8.

23. A non-transitory computer-readable storage medium having a computer program stored thereon, wherein the computer program, when executed by a processor, causes the processor to implement the data acquisition method for a weight matrix according to claim 8.
